(19) United States
(12) Patent Application Publication
(10) Pub. No.: US 2008/0027871 A1
(43) Pub. Date: Jan. 31, 2008

(54) UPDATE METHOD AND UPDATE SYSTEM

(75) Inventor: Shinichiro Seo, Tokyo (JP)

Correspondence Address: PEARNE & GORDON LLP, 1801 EAST 9TH STREET, SUITE 1200, CLEVELAND, OH, 44114-3108, US

(73) Assignee: Ziosoft, Inc., Tokyo (JP)

(21) Appl. No.: 11/777,593

(22) Filed: Jul. 13, 2007

(30) Foreign Application Priority Data
Jul. 31, 2006 (JP) 2006-208131

(51) Int. Cl. H04L 9/00

(52) U.S. Cl. 705/59

(57) ABSTRACT

An update system includes: a program server for storing application programs and transmitting the application program corresponding only to an authenticated client; a license server for transmitting information concerning the authenticated client to the program server and transmitting the license key of the application program to the authenticated client; and the client for executing the application program transmitted from the program server based on the license key transmitted from the license server.

This application claims foreign priority based on Japanese Patent application No. 2006-208131, filed Jul. 31, 2006, the contents of which are incorporated herein by reference in its entirety.

### BACKGROUND OF THE INVENTION

1. Field of the Invention

This invention relates to an update method and an update system of a medical application program used by a client.

2. Description of the Related Art

In medical application programs used in medical facilities, license is finely configured for each medical facility and each medical practice department; for example, license is separately issued to a heart-specific application program, a brain-specific application program, each of their versions and the like for separate management. Since diagnosis criterion, etc., varies from one medical facility to another, individual fine requirements are involved in the algorithm and setting condition used by an application. An application of special specifications may be provided for a specific medical facility. Unlike general-purpose application programs, the medical application programs require complicated management as described above. Thus, to update the medical application program, it is a common practice for the person in charge of the program in the software developer or the distributor of the program to operate the client directly.

As one method of updating a medical application program through a network, all application programs are stored in a server of a distributor and can be downloaded to a client, and the client given the license of an individual application program is given a license key corresponding to the individual application program for management.

FIGS. 10A and 10B show a system in a related art for the software developer or the distributor to manage an application program used by a client. In the system in the related art, an application program is transmitted from a program server 111 storing the application program to a client 113, as shown in FIG. 10A. Next, a license server 112 creates a license key according to the client 113 for executing the application program and passes the license key to the client 113, as shown in FIG. 10B.

Thus, in the system in the related art, the application programs are stored in the program server 111 on a network and the client 113 can download all the application programs. However, since the downloaded application program is encrypted or the service period of the downloaded application program is limited, the client 113 cannot execute the downloaded application program unless the client 113 obtains the license key from the license server 112.

Thus, in the system in the related art, although the application programs are encrypted or the service period of each application program is limited, the client 113 can acquire all application programs stored in the program server 111 as desired.

Thus, in the medical application programs wherein the available versions and options, additional settings, and selected algorithms are finely configured for each medical facility and each medical practice department, consistency among application programs may be lost as they are repeatedly updated. Since all application programs can be downloaded to the client, there is a possibility that an incorrect option selection or unauthorized use of the application may occur. Particularly, erroneous use of a test and research application program or application program settings and algorithms customized for a specific medical facility can cause a serious medical disaster. Since it is not preferable for a person who is not a health care professional to contact the client and the program server for the reasons of maintenance and sanitary, the manufacturer that provides the medical application programs cannot necessarily manage the client or the program server.

### SUMMARY OF THE INVENTION

The present invention has been made in view of the above circumstances, and provides an update method and an update system that can update an application program safely and efficiently in response to a given license.

In some implementations, an update method of the invention in an update system including a license server, a program server and a client, the update method comprises:

storing a medical application program in the program server;

acquiring client information of the client by the license server;

creating by the license server a license key corresponding to the client information;

creating by the license server a license information concerning the medical application program permitted for the client based on information in the license server that can be set by a person having a predetermined authority; and

transmitting by the program server the medical application program in accordance with the license information, to the client for executing the medical application program.

According to the update method of the invention, the program server transmits only the dedicated medical application program to each client in accordance with the client information, and after acquiring the license key from the license server, each client can execute the transmitted medical application program. Thus, an unlicensed medical application program is not transmitted to any client and the application program can be updated safely and efficiently in response to the given license. Once the authorized person sets the license server, only the license server is managed strictly, and even an unauthorized person can update the medical application program stored in the program server, so that the application program can be updated in response to the given license with more safety and efficiently. This is based on the difference such that license, namely, the number of sold commodity products, etc., is stored in the license server and a person having the authority to handle money manages the license server and that the application programs are stored in the program server and a person who does a maintenance check on the system manages the program server.

The update method, further comprises:

acquiring an ID of the client by the program server; and

transmitting the client information to the license server by the program server.

According to the update method of the invention, if the client updates the version of an application program, only the authority to access the program server is given to the client, whereby the version of the application program can be updated safely.

The update method, further comprises:

acquiring the license key from the license server by the client.

According to the update method of the invention, in distributing an application program, the program server and the license server are separated, whereby the application program can be distributed safely if the license server is only strictly managed.

In the update method, the license information includes application information of the application program.

According to the update method of the invention, the license information created by the license server includes the application information of version management information and combination information, so that the program server can transmit only the application program of the version permitted for the client to the client and the possibility of losing consistency among the versions is eliminated.

In the update method of the invention, the license information includes at least one of an algorithm or a setting variable used by the application program.

According to the update method of the invention, the license information created by the license server includes the algorithm or the setting variable used by the application program, so that the application program having a special algorithm created for each medical facility and the application program having a special setting variable can be updated safely and efficiently.

In some implementations, an update system of the invention, comprises:

a program server for storing a medical application program, and transmitting the medical application program to a client;

a license server for transmitting license information concerning the client to the program server, and transmitting a license key of the medical application program to the client; and

the client for executing the medical application program transmitted from the program server based on the license key transmitted from the license server,

wherein the license server is accessed by a person having a predetermined authority.

According to the update system of the invention, the program server transmits only the dedicated medical application program to each client in accordance with the client information, and after acquiring the license key from the license server, each client can execute the transmitted medical application program, so that the medical application program can be updated safely and efficiently in response to the given license in the client.

In the update system of the invention, the client serves as a rendering server.

In the update system of the invention, the license server and the program server are included in one apparatus.

In the update method of the invention, the license server manages the license of the medical application program, the program server stores the medical application program, and the client executes the medical application program.

In the update system of the invention, the license server manages the license of the medical application program, the program server stores the medical application program, and the client executes the medical application program.

### BRIEF DESCRIPTION OF THE DRAWINGS

In the accompanying drawings:

FIG. 1 is a drawing to show an outline to describe an update system according to an embodiment of the invention;

FIG. 2 is a drawing to show step 1 of an update method according to the embodiment of the invention;

FIG. 3 is a drawing to show step 2 of the update method according to the embodiment of the invention;

FIG. 4 is a drawing to show step 3 of the update method according to the embodiment of the invention;

FIG. 5 is a drawing to show step 4 of the update method according to the embodiment of the invention;

FIG. 6 is a drawing to show step 5 of the update method according to the embodiment of the invention;

FIG. 7 is a drawing to describe Example 1 (version management) in the update system of the embodiment of the invention;

FIG. 8 is a drawing to describe Example 2 (rendering server) in the update system of the embodiment of the invention;

FIG. 9 is a drawing to describe Example 3 (encryption) in the update system of the embodiment of the invention; and

FIGS. 10A and 10B are drawings to show a system in a related art for a manufacturer to manage an application program used by a client.

### DESCRIPTION OF THE PREFERRED EMBODIMENTS

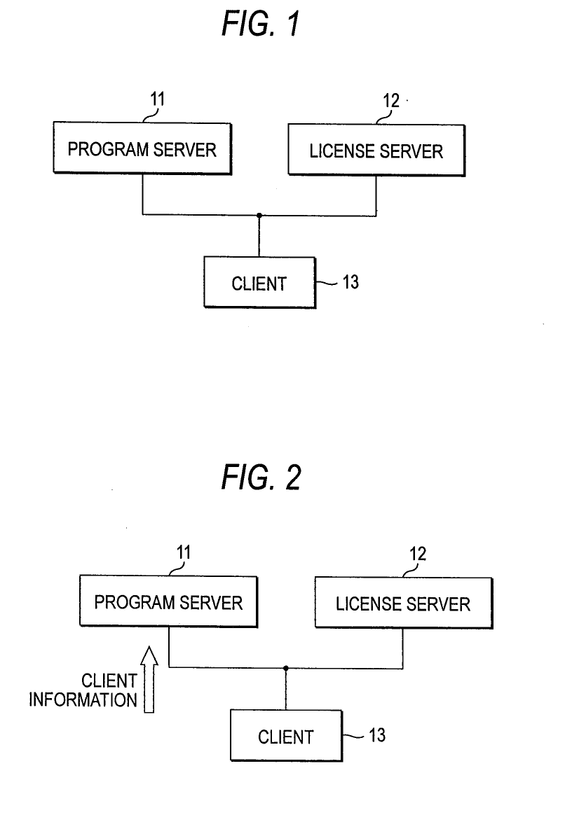

FIG. 1 is a schematic drawing to describe an update system according to an embodiment of the invention. The update system of the embodiment is intended for updating medical application programs and includes a program server 11 for storing application programs and transmitting the application program corresponding only to a client 13, a license server 12 for transmitting information concerning the client 13 to the program server 11 and transmitting the license key of the application program to the client 13, and the client 13 for executing the application program transmitted from the program server 11 based on the license key transmitted from the license server 12. The license server 12 can be accessed only by a person having a predetermined authority.

The client information is an ID for uniquely identifying the client 13 and a key for determining the client 13 and includes information used for creating the license key, etc., for identifying the client 13 and permitting only the client 13 to execute the application program, such as the hardware number of a hard disk, for example. The license information includes the client information and further application information permitted for the client 13.

The application information permitted for the client includes the functions permitted for the client such as a main function, a cardiac function analysis expansion function, and perfusion function and a combination thereof and the limitations or minimum requirements of the specifications permitted for execution of application program, such as the number of CPUs, the upper limit of the HDD capacity, and permission or no permission of a removable medium.

In this case, the application information permitted for the client 13 is representation with given flexibility across a plurality of versions, etc., like program (function) from A3, program (function) B4 or program (function) B5β, program C5-C10 (the numeric value is the version number). In so doing, the application information also includes information concerning the development version and the special specification version of each program.

Thus, in the update system of the embodiment, the program server 11 transmits only the dedicated application program to each client 13 in accordance with the client information. After acquiring the license key from the license server 12, each client 13 executes the transmitted application program. Thus, an unlicensed application program is not transmitted to any client 13 and the possibility of losing consistency among the versions is eliminated. The license server 12 manages the application programs that can be combined, application program settings, and the versions of the application programs, so that occurrence of a incorrect option selection and occurrence of unauthorized use of an unlicensed application program can be prevented. Therefore, the application program can be updated safely and efficiently in response to the given license.

To distribute an application program, the program server 11 and the license server 12 are separated, whereby the application program can be distributed safely if the license server 12 only is strictly managed.

Therefore, for example, if the client 13 updates the version of an application program, only the authority to access the program server 11 is given to the client 13, whereby the version of the application program can be updated safely.

Next, an update method according to the embodiment of the invention will be discussed in detail for each step. FIG. 2 shows step 1 of the update method according to the embodiment of the invention. At step 1, the program server 11 gets client information containing the ID of the client 13.

That is, the client 13 transmits client information containing the ID of the client 13 and information used as material of the license key, etc., for permitting only the client 13 to execute the application program to the program server 11.

Step 1 is only for the program server 11 to identify the client 13; in the embodiment, the client 13 does not select an application program, but implementation can also be expanded so as to enable the client 13 to select an application program.

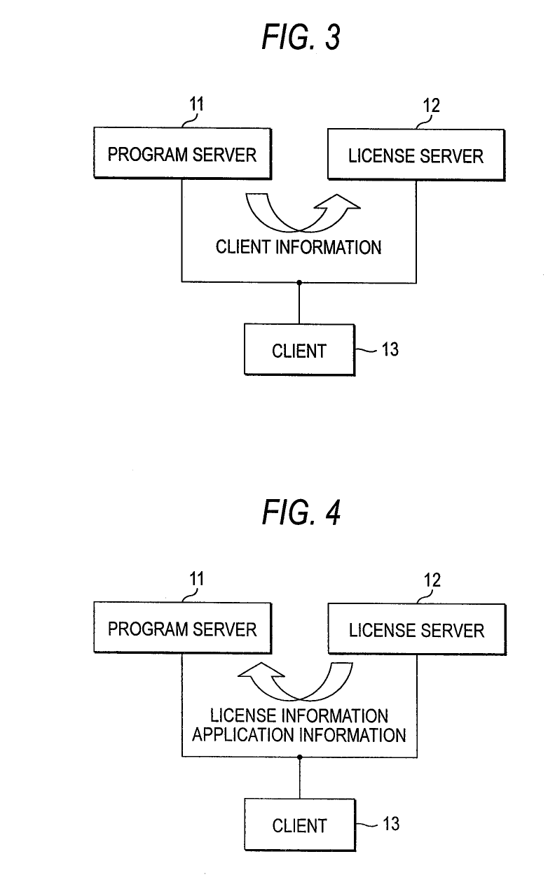

FIG. 3 shows step 2 of the update method according to the embodiment of the invention. At step 2, the program server 11 transmits the client information of the client 13 to the license server 12.

In this case, the license server 12 previously holds the license information indicating what license each client 13 has. Therefore, the license server 12 also holds the client information contained in the license information.

At step 2, the program server 11 inquires of the license server 12 about the license information and thus the license server 12 requires the client information to identify the license information. Although only the ID of the client 13 is sufficient for selecting an application program to be provided, only the ID of the client is insufficient for encrypting the application to permit only the client 13 to execute the application program and therefore information of a hardware key, etc., is also acquired for ensuring identification of the client. The client information is also used for later license key creation.

FIG. 4 shows step 3 of the update method according to the embodiment of the invention. At step 3, the license server 12 determines the range of the application program dependent on the client information and transmits the license information and the application information to the program server 11.

The application information dependent on the client information is data for determining the application program actually distributed to the client 13 by the program server 11, such as program A5, program B4, or program C10, for example. The application information can be preset for each client ID, for example. It can also be obtained from a preset condition. In so doing, an application program or application program version not existing at the setting time can also be newly contained in the application information.

By using the application information of the application programs permitted for the client 13, dependent on the client information of the client 13, an encryption key for encrypting the application to permit only the client 13 to execute the application at the time is also transmitted. Accordingly, if the user illegally gets an application program not permitted for the client 13, the user can be prevented from executing the application program.

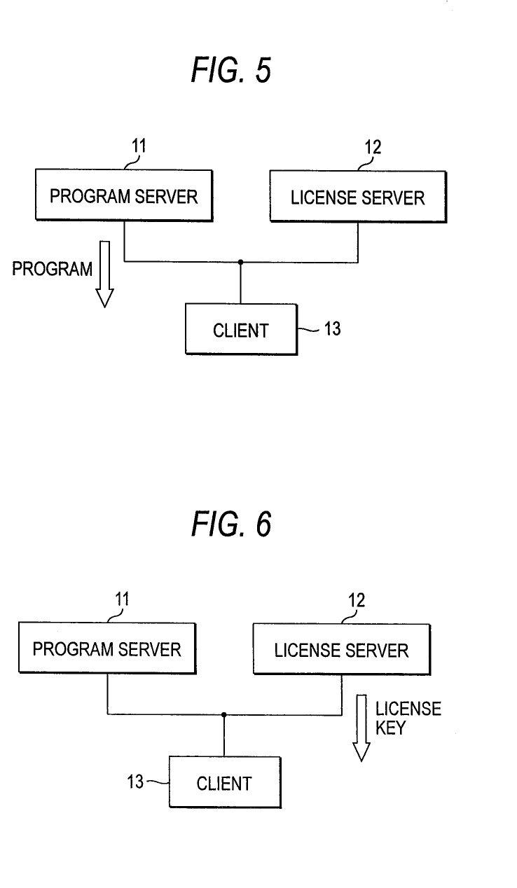

FIG. 5 shows step 4 of the update method according to the embodiment of the invention. At step 4, the program server 11 transmits the application program responsive to the application information of the program transmitted from the license server 12 to the client 13. The program server 11 determines which application program is to be downloaded to the client 13 based on the application information.

At step 4, the program server 11 transmits only the dedicated application program to each client 13 in accordance with the client information. Thus, an unlicensed application program is not transmitted to any client 13 and an application program of an erroneous version is not transmitted either, so that the application program can be updated safely and efficiently in response to the given license.

FIG. 6 shows step 5 of the update method according to the embodiment of the invention. At step 5, the license server 12 makes a request for the client information of the client 13 and if it matches the license information held by the license server 12, the license server 12 transmits a license key to the client 13.

The license key is a cryptographic decryption key or a similar code created based on the client information and the application information of the program dependent on the client information and becomes necessary at the execution time of the application program. The client 13 executes the application program in combination with the license key.

At step 3, using the application information of the application programs permitted for the client 13, transmitted from the license server 12, the program server 11 prepares the application program containing the application information of the application programs permitted for the client 13 and transmits the application program to the client 13 and therefore the application program that can be referenced by the client 13 includes the limitation based on the application information of the application programs permitted for the client 13.

Thus, in the update system of the embodiment, the program server 11 transmits only the dedicated application program to each client 13 in accordance with the client information. After acquiring the license key from the license server 12, each client 13 executes the transmitted application program. Thus, an unlicensed application program is not transmitted to any client 13 and the application program can be updated safely and efficiently in response to the given license. In so doing, the application program having a special algorithm created for each medical facility and the application program having a special setting variable can be updated safely and efficiently.

To distribute an application program, the program server 11 and the license server 12 are separated, whereby the application program can be distributed safely if the license server 12 only is strictly managed. In so doing, if the program server 11 and the license server 12 are installed in a location where access of an outsider is limited, it is made possible for an insider to update the program stored in the program server 11 via a record medium, whereas it is made possible to set the license information stored in the license server 12 when access limitation is temporarily released when the license server 12 is installed. It is also made possible to distribute the same record medium to a plurality of medical facilities, so that the cost of creating individual record media can be reduced.

Therefore, for example, if the client 13 updates the version of an application program, only the authority to access the program server 11 is given to the client 13, whereby the version of the application program can be updated safely. This is effective particularly in an environment in which external communications are limited as in medical facilities.

### EXAMPLE 1

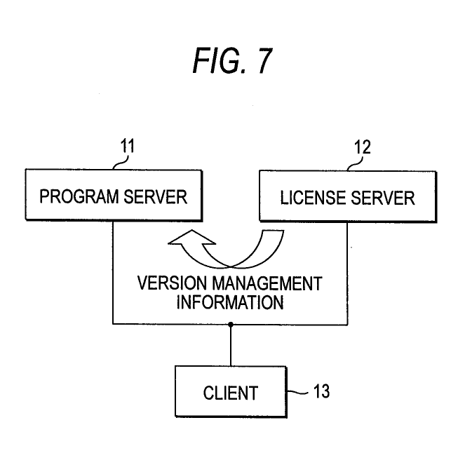

FIG. 7 is a drawing to describe Example 1 (version management) in the update system of the embodiment. In the example, version management information is added to the license information created by the license server 12.

Therefore, as the application information of the application programs permitted for the client 13, if the functions permitted for the client 13 are the main function, the cardiac function analysis expansion function, the perfusion function, etc., the version management information of the main function version, the cardiac function analysis expansion function version, the perfusion function version, etc., is contained. Accordingly, the range such that versions are 1.00 to 3.50 can be defined as the application (function) combination limitation. Then, the program server 11 determines the specific application program version using the version management information contained in the application information, and transmits the application program of the version to the client.

Thus, in the update system of the example, the license information created by the license server 12 includes the version management information, so that the program server 11 can specifically determine the application program of the appropriate version from among the application programs of the versions permitted for the client 13 and can transmit the application program of the version to the client 13 and the application program can be updated safely and efficiently in response to the given license. Since the application information also includes information concerning the combination of the versions among the application programs, the version consistency among the application programs can also be provided.

### EXAMPLE 2

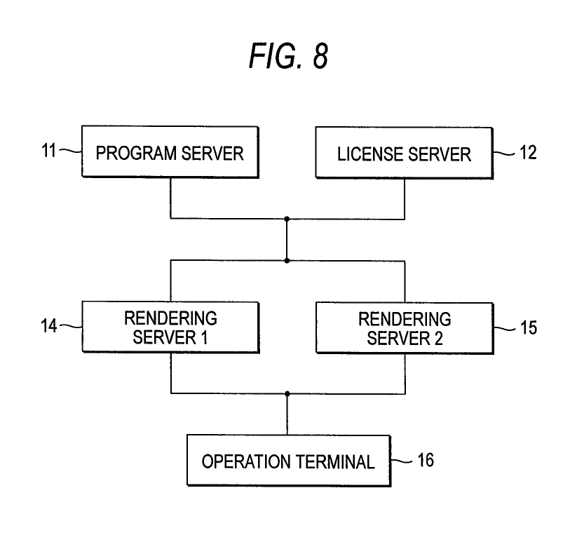

FIG. 8 is a drawing to describe Example 2 (rendering server) in the update system of the embodiment. In the example, an operation terminal 16 can access a rendering server 14 and a rendering server 15. For example, the rendering server 14 has a main function and functions A and B and the rendering server 15 has a main function and functions A, C, and D. Thus, the clients can be assigned different roles as an operation terminal or a rendering server.

If calculation of image processing is executed in the rendering server 14 and the rendering server 15, the application programs are transmitted to both of the rendering server 14 and the rendering server 15 and the operation terminal 16. At this time, the application program transmitted to the rendering server 14 and the rendering server 15 may be an image processing program and the application program transmitted to the operation terminal 16 may be an image display program.

Information of the rendering server 14 and the rendering server 15 that can be used for each application is added to the license information of the operation terminal 16. The applications that can be installed are set in the rendering server 14 and the rendering server 15.

Thus, in the update system of the example, the information of the rendering server that can be used for each application is added to the license information of the operation terminal 16, so that the program server 11 can transmit only the application program corresponding to the rendering server permitted for the operation terminal 16 to the operation terminal 16, and function selection for the rendering server is facilitated. Limitation of the rendering servers that can be used can also be added to the operation terminal 16.

### EXAMPLE 3

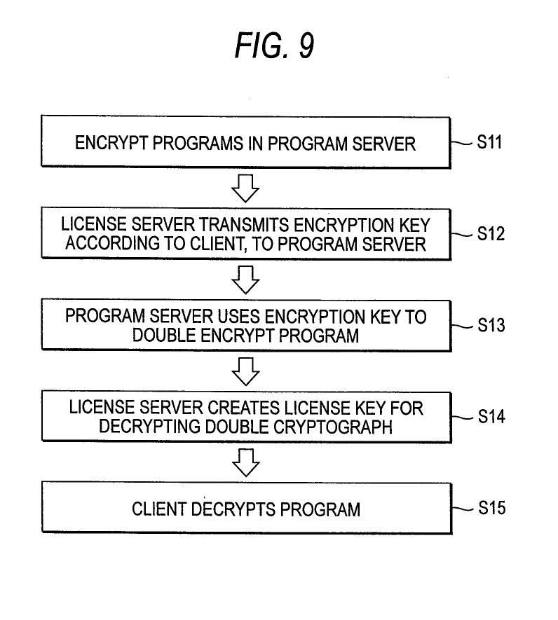

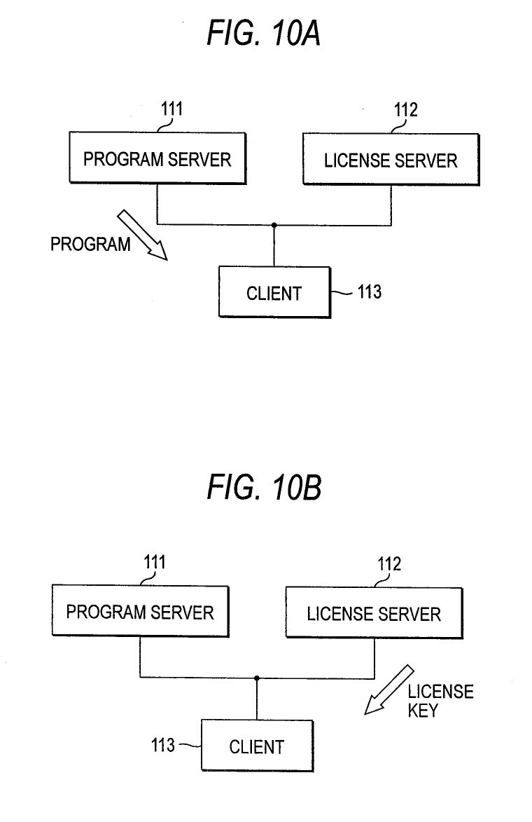

FIG. 9 is a drawing to describe Example 3 (encryption) in the update system of the embodiment. In the example, the program server 11 double encrypts an application program and transmits the encrypted application program to the client 13, whereby the application program can be distributed with more safety.

That is, each application program stored in the program server 11 is previously encrypted (step S11). The license server 12 transmits the encryption key responsive to the client 13 to the program server 11 (step S12).

Next, the program server 11 uses the encryption key transmitted from the license server 12 to double encrypt the application program (step S13). Further, the license server 12 creates a decryption key (license key) for decrypting the double cryptograph (step S14).

The client 13 acquires the license key for decrypting the double cryptograph from the license server 12 and decrypts the double encrypted application program transmitted from the program server 11 (step S15).

Thus, in the update system of the example, the program server 11 double encrypts an application program and transmits the encrypted application program to the client 13, so that the application program can be updated safely and efficiently. In so doing, if a malicious person acquires the application program stored in the program server 11 by illegal operation, etc., the application program is placed in an unexecutable state and thus only the security of the license server 12 needs to be strengthened.

In the update system of the invention, in addition to the embodiment described above, the license server or the program server can reference the application program already installed in the client. In so doing, updating the application program can be completed inheriting the complicated special settings before update, so that the application program can be updated with more safety. It is effective particularly for a medical facility wherein a test algorithm is used only in some terminals.

In the update system of the invention, in addition to the embodiment described above, the license server or the program server can reference the past update processing history of the client. In so doing, updating the application program can be completed inheriting the past update process, so that the application program can be updated with more safety. It is effective particularly for a medical facility wherein update is ceased and an old version is selected and is used due to circumstances. In this case, if the user attempts to update to the most recent version, the user can be warned of the fact that update was ceased in the past.

In the update system of the invention, in addition to the embodiment described above, as update processing, an application program can be replaced, can be added, and can be newly installed in addition to alteration of the application program.

The invention can be used as the update method and the update system that can update each application program safely and efficiently in response to the license.

According to the invention, the program server transmits only the dedicated medical application program to each client in accordance with the client information and after acquiring the license key from the license server, each client can execute the transmitted medical application program. Thus, an unlicensed medical application program is not transmitted to any client, so that the application program can be updated safely and efficiently in response to the given license.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An update method in an update system including a license server, a program server and a client, the update method comprising:
storing a medical application program in the program server;
acquiring client information of the client by the license server;
creating by the license server a license key corresponding to the client information;
creating by the license server a license information concerning the medical application program permitted for the client based on information in the license server that can be set by a person having a predetermined authority; and
transmitting by the program server the medical application program in accordance with the license information, to the client for executing the medical application program.

2. The update method as claimed in claim 1, further comprising:
acquiring an ID of the client by the program server; and
transmitting the client information to the license server by the program server.

3. The update method as claimed in claim 1, further comprising:
acquiring the license key from the license server by the client.

4. The update method as claimed in claim 1, wherein the license information includes application information of the application program.

5. The update method as claimed in claim 1, wherein the license information includes at least one of an algorithm or a setting variable used by the application program.

6. An update system, comprising:
a program server for storing a medical application program, and transmitting the medical application program to a client;
a license server for transmitting license information concerning the client to the program server, and transmitting a license key of the medical application program to the client; and
the client for executing the medical application program transmitted from the program server based on the license key transmitted from the license server,
wherein the license server is accessed by a person having a predetermined authority.

7. The update system as claimed in claim 6, wherein the client serves as a rendering server.

8. The update system as claimed in claim 6, wherein the license server and the program server are included in one apparatus.

9. The update method as claimed in claim 1, wherein the license server manages the license of the medical application program, the program server stores the medical application program, and the client executes the medical application program.

10. The update system as claimed in claim 6, wherein the license server manages the license of the medical application program, the program server stores the medical application program, and the client executes the medical application program.
